(19) United States
(12) Patent Application Publication
(10) Pub. No.: US 2006/0151400 A1
(43) Pub. Date: Jul. 13, 2006

(54) Biosolids stabilization process

(75) Inventors: Frederick P. Mussari, Melbourne, FL (US); Wilfried J. Schmitz, Jacksonville, FL (US)

Correspondence Address: MORRISON & FOERSTER LLP, 1650 TYSONS BOULEVARD, SUITE 300, MCLEAN, VA, 22102, US

(73) Assignee: BioChem Resources, St. Augustine, FL (US)

(21) Appl. No.: 11/293,501

(22) Filed: Dec. 5, 2005

Related U.S. Application Data
(60) Provisional application No. 60/632,693, filed on Dec. 3, 2004.

(51) Int. Cl. C02F 11/00

(52) U.S. Cl. 210/754

(57) ABSTRACT

A method utilizing chlorine dioxide and, optionally, and acid or other non-charged chemical species for the treatment of biosolids to destroy pathogens is provided. The method uses chlorine dioxide to modulate the ORP of the matrix. In one embodiment, the invention employs acidification of the sludge (biosolids) to a pH of less than 4.0, and provides for the addition of nitrous acid for enhanced disinfection in a closed system to prevent volitalization.

### CROSS REFERENCE TO RELATED APPLICATION

This application claims the priority of U.S. Provisional Application Ser. No. 60/632,693, filed Dec. 3, 2004, which is hereby incorporated by reference in its entirety.

### FIELD OF THE INVENTION

Disclosed is a method for reducing vector attraction in water and/or waste water to improve stabilization of biosolids. Using chlorine dioxide or other chemical oxidants vector attraction may be reduced, thereby lowering the risk of vectors that may transport pathogens to other locations. The present invention relates, generally, to municipal or agricultural wastewater treatment and more particularly relates to an improved method of biosolids treatment wherein vector attraction reduction and stabilization are accomplished by utilizing a chemical oxidant such as chlorine dioxide.

### BACKGROUND OF THE INVENTION

In the treatment of wastewater, a sludge product is generated. As the resulting biosolids contain nutrient value as a soil amendment, and are disposed of by land application, there is a need to both reduce the number of pathogens in the solid, and to reduce its attraction of vectors (birds, flies, animals) that could transport pathogens to other locations. This problem of pathogen reduction has been the subject of numerous articles.

U.S. Pat. No. 5,281,341, entitled “Sludge Treatment Process” describes a method of treating a liquid waste or process stream that includes a sludge component and that enhances sludge treatment or stabilization. The sludge is acidified to a pH of less than 4.0 in an oxygen enriched environment. A nitrous acid level is maintained sufficiently high to kill pathogens, in a closed chamber so that the nitrous acid won't be lost from the chamber through volatilization. U.S. Pat. No. 5,281,341 is incorporated herein by reference.

U.S. Pat. No. 4,936,983, entitled “Sewage Sludge Treatment With Gas Injection,” relates to an apparatus for treating sewage sludge in a hyperbaric vessel in which the sludge is oxygenated by injecting an oxygen-rich gas into the sewage sludge and then dispersing the mixture of sludge and oxygen-rich gas into the upper portion of a hyperbaric vessel for further interaction with an oxygen-rich atmosphere. The oxygen-rich gas is injected into the sewage sludge by delivering the gas to a combination gas and sludge mixing and dispersing assembly. This patent teaches a process to stabilize municipal sludge by acidifying the sludge to a pH of between 2.5 and 3.5 in the presence of 200 to 300 ppm (parts per million) of oxygen at a pressure of 60 psi and a pure oxygen stream containing 3.0% to 6.0% ozone for a period of 30-90 minutes. The process was ineffective against viruses and Ascaris eggs. These data indicate PSRP and PFRP inactivation criteria being met for bacteria only. U.S. Pat. No. 4,936,983 is hereby incorporated herein by reference in its entirety.

The problem of disinfection and stabilization of municipal and agricultural wastes is global. The present invention teaches a method that offers significant performance and economic advantages over known methods to make the treatment of this material practical for both municipalities and agricultural operations.

### SUMMARY OF THE INVENTION

The present invention provides an improved method of treating liquid waste or process streams that include a sludge component and that enhance sludge disinfection and stabilization.

Chlorine dioxide is known to be a strong oxidant and a potent biocide. In testing for disinfection of biosolids, it was discovered that while capable of inactivating bacteria and viruses, chlorine dioxide alone is not able to inactivate Ascaris eggs at concentrations as high as 1000 ppm. Non-charged chemical species are capable of penetrating the shell of ascaris eggs under certain conditions and Nitrous acid is capable of Ascaris inactivation in biosolids at concentrations above 400 mg/L in a closed system.

The non-ionic, or non-charged, species of a chemical in a waste stream can be maintained by controlling the pH and/or ORP of the mixture. The use of Ozone for ORP control, and nitrous acid as the penetrant for Ascaris inactivation is suggested.

It has been found that chlorine dioxide has a number of unexpected advantages over ozone for this purpose. While ozone is a more powerful oxidant than chlorine dioxide, chlorine dioxide is a more specific oxidant and is able to raise and maintain the ORP of a sludge sample for a long enough period of time to allow inactivation of bacteria, viruses, and Ascaris eggs.

In one embodiment, the invention relates to the use of chlorine dioxide to control ORP in sludge, thus increasing the performance of disinfection due to non-charged chemical species, as well as through the performance of the chlorine dioxide itself as a disinfectant. The chlorine dioxide has an added benefit of enhancing the stability of the end product. This method yields a significant reduction in a biosolid's vector attraction in a short period of time.

### DETAILED DISCLOSURE OF THE PREFERRED EMBODIMENTS

The present invention provides an improved method of treating liquid waste or process streams that include a sludge component and that enhances sludge disinfection and stabilization.

Chlorine dioxide is known to be a strong oxidant and a potent biocide. (ref). During the development of a system for the disinfection of biosolids to meet EPA Class A standards, it was discovered that the system was also able to reduce vector attraction and induce stability in treated biosolids through reduction of volatile solids content. Testing has demonstrated that volatile solids (VS) reductions ranging from 40-90% can be achieved using this method.

While vector attraction reduction can be accomplished by biological processes which breakdown volatile solids, thus reducing the available food nutrients for microbial activities, the discovery of a chemical method to accomplish this has profound implications on the design of wastewater treatment facilities in that it can eliminate the biological processes, leaving more available nutrients in the remaining solids for beneficial use. The process also greatly reduces the volume of biosolids generated, as the reduction in volatile solids results in lower total solids production.

Disclosed herein is the use of a chemical oxidant, such as chlorine dioxide, to reduce vector attraction in biosolids, and further to induce stability. Stability is generally defined as the point at which food for rapid microbial activity is no longer available.

Although biosolids which are stable generally meet vector attraction requirements, there are conditions which can disrupt this stability, such as cell lysis caused by mechanical factors such as vacuum drying or high speed centrifugation, which renders the material unstable and attractive to vectors. In addition, material which does meet vector attraction requirements is not necessarily stable, and is still capable of producing odors and sustaining bacterial growth, both pathogenic and non-pathogenic.

The subject invention is directed to novel methods of treating agricultural or municipal biosolids. The subject methods utilize a chemical oxidant to reduce vector attraction to, and stabilize, biosolids. In a preferred embodiment, the addition of the oxidant is carried out in a closed vessel (tank or pipe) so that the volatile organics emitted can be filtered or otherwise removed to prevent odors. Sufficient contact time is provided to allow for vector attraction reduction, which can occur in a matter of minutes, and to induce stability, which can take a longer time, up to several hours.

In a preferred method, the biosolids are at a relatively neutral pH (5-9) at the time of treatment. Further, when the chlorine dioxide level is less than 50 parts per million, stability may be induced in less than 2 hours. Chlorine dioxide levels of up to 1% (10,000 ppm) may be used, but may be effectively prohibitive over about 100 ppm, due to usage restrictions, handling concerns, and treatment costs. The solids level of the waste stream is preferred to be less than 7% suspended solids, although it may be conducted with any level of suspended solids.

The present process can produce biosolids that meet vector attraction reduction requirements within 2-4 hours, and are biologically stable. The controlling element of the process is based around the effect that chlorine dioxide has on the volatile solids in the biosolids. This process is capable of stabilizing raw or semi-stabilized biosolids, or of reducing attraction and inducing stability in material that has been disinfected in another process and has been rendered unstable by mechanical means.

Currently, biosolids are generally stabilized by one of the following methods:

1. Mesophilic composting

2. Alkaline stabilization

3. Head drying to pellets (solids content>90%)

4. Aerobic or anaerobic digestion

The present method of stabilization and vector attraction reduction for municipal or agricultural biosolids has significant advantages in both time savings and economic savings for municipalities and other wastewater treatment operations. Energy demands of a municipal wastewater plant can account for 30-50% of the total demand of a municipality. This method offers tremendous economic savings in this regard, by reducing the amount of time and energy necessary to effect biosolids stabilization and a reduction in vector attraction.

The stability of treating biosolids can be controlled by the pre-digestion processes, such as aerobic or anaerobic mesosphilic digestion. In the nitrous acid treatment, the oxidation step can enhance the stability of the resulting biosolids since the mixed oxidants should not lyses cells. Respirometer analysis was conducted to assess stabilization of the end product.

The ultimate goal is to produce a biosolid that meets Class A standards for disinfection and stability. The resulting biosolid may then be land applied or may have other uses as a fertilizer or soil amendment. If the process proves effective, it may also prove useful in the treatment of manure, waste material from agricultural applications, shipboard wastes such as grey and black water and medical waste materials.

In a preferred method, the sludge is acidified to a pH of between 2.5 and 3.5. The nitrous acid level should be greater than 400 parts per million, and the pathogen kill is in about 2-12 hours. The ORP of the sludge is maintained at +200-+600 mV. In a preferred method, the solids level of the waste stream is less than 7% suspended solids. Further, the nitrous acid level is in excess of 1500 milligrams per liter and the pathogen kill is in 4 hours or less.

An embodiment of the present process may produce a Class A disinfected/stabilized biosolids within 4 hours. This process produces a disinfected/stabilized-thickened biosolid that yields a Class A biosolids product. The process uses a low pH (between 2 to 3, for example) utilizing a sodium nitrite/sodium bisulfate to both disinfect and stabilize. The controlling element of the process is based around the oxidizing potential of nitrite (NO₂⁻). In an acidic environment; this oxidizing reaction is applied to the residual biosolids fed through the process. The acidic conditions are achieved by dosing sodium bisulfate solution into the liquid biosolids while simultaneously dosing nitrites in the form of sodium nitrite solution. The ORP is controlled utilizing chlorinated mixed oxidants (chlorite-hypochlorite/chlorine dioxide). These are then mixed together for approximately 30 to 120 minutes in a batch reactor vessel where pathogenic organisms are inactivated.

### EXAMPLE 1

In a closed vessel, an unstabilized biosolids having a pH of 6.0 is contacted with 50 ppm of ClO₂. A contact time of 2 hours yields a stabilized, thickened biosolid and a significant reduction in vector attraction, due to a substantial decrease in volatile solids.

### EXAMPLE 2

In this process, sodium nitrite under pH at 3 was used to disinfect aerobically or anaerobically digested municipal sludges having a solids percentage in the range of 0.1% to about 10.0%. The acidic conditions were achieved by dosing sodium bisulfate solution into the sludges, while simultaneously dosing mixed oxidants (sodium hypochlorite, sodium chlorite and chlorine dioxide) to control ORP levels ranging from 300 to 600 mv. The chlorite-hypochlorite added to the acidified sludge provides in-situ generation of chlorine dioxide. Then, 1500 mg/L of nitrite in the form of sodium nitrite solution was added into the system. These were mixed together in a closed system. In this process, the municipal aerobically or anaerobically digested biosolids were spiked with pathogenic spikes and also monitored for indicator organisms, Aerobic endospores and Somatic bacteriophages. Among these tests, one duplicate and one control were conducted for QA/QC purposes. After the exposure periods, the treated sludges were collected in polyethylene bottles and neutralized using 6 N sodium hydroxide. The efficiency of disinfection was illustrated by percentage of viability of Ascaris eggs in the control and after the treatment. In addition, the controlled parameters were tested to establish a matrix of nitrous acid treatment for inactivating Ascaris eggs. The parameters include pH, temperature, ORP, contact time, solid content and pressure.

What is claimed is:

1. A method for reducing the vector attraction of a biosolid, comprising: contacting the biosolid with a chemical oxidant in a closed vessel.

2. The method of claim 1 wherein the chemical oxidant is chlorine dioxide.

3. The method of claim 1, comprising adjusting the pH of the biosolid prior to contact with the chemical oxidant, using a chemical selected from the group consisting of sodium bisulfate, sulfuric acid, citric acid, phosphoric acid, hydrochloric acid, and combinations and admixtures thereof.

4. The method of claim 1 wherein the ORP of the biosolid after chemical oxidant addition is ≧50 mv.

5. The method of claim 3 wherein the ORP of the biosolid after chemical oxidant addition is ≧50 mv.

6. The method of claim 1 wherein the biosolid comprises a municipal sludge.

7. The method of claim 1 wherein the biosolid comprises anaerobically or aerobically digested sludge.

8. The method of claim 1 wherein the biosolid comprises from about 0.5% to about 8% solids content.
